(19) United States
(12) Patent Application Publication
(10) Pub. No.: US 2006/0246805 A1
(43) Pub. Date: Nov. 2, 2006

(54) Odor controlling liner

(76) Inventor: Nancy Swierczk, Princeton, NJ (US)

Correspondence Address: LAW OFFICES OF ARTHUR E. JACKSON, P.O. BOX 88, HOPEWELL, NJ, 08525, US

(21) Appl. No.: 11/115,458

(22) Filed: Apr. 27, 2005

(51) Int. Cl. B32B 7/12; B32B 27/12; D04H 1/00

(52) U.S. Cl. 442/394; 442/417; 428/343

(57) ABSTRACT

Provided, among other things, is a composite liner material comprising: a water-impermeable layer; sandwiched between the water-impermeable layer and a water-absorbent layer, a layer comprising an odor absorbent; and the water absorbent layer, wherein the three layers are flexible and sufficiently bonded so that the composite is conveniently manipulated for use as a liner.

The present invention relates to a composite liner having a tacky lower layer, an odor-absorbing sandwiched layer, and a water absorbent third layer.

When spills occur in a refrigerator, they quickly harden and often spoil. Because of the tight spaces in a refrigerator, it can be difficult and time-consuming to clean such spills. Cold temperatures make the job harder. Also, generally groceries are on hand that need refrigeration during the clean up, so a long clean up that leaves these items susceptible to spoilage is undesirable. The present invention provides an easy to use liner with an odor control feature for use in this context, as well as any context where a surface liner is useful.

### SUMMARY OF THE INVENTION

In one embodiment, the invention relates to a composite liner material comprising: a water-impermeable layer; sandwiched between the water-impermeable layer and a water-absorbent layer, a layer comprising an odor absorbent; and the water absorbent layer, wherein the three layers are flexible and sufficiently bonded so that the composite is conveniently manipulated for use as a liner. The water-impermeable layer can be, for example, tacky but reversibly removable from a lined surface. The composite liner can be, for example, provided in a roll comprising perforations for separating individual segments of composite liner, and essentially free of a separate release layer. The water-impermeable layer can be, for example, a plastic film. The composite liner can be provided with packaging comprising instructions on using the liner as a protective liner.

In another embodiment, the invention relates to method of lining a surface subject to spills comprising placing on the surface the composite liner with the tacky layer adjacent to the surface.

### BRIEF DESCRIPTION OF THE DRAWINGS

FIG. 1a displays a dispenser for the composite liner.

FIG. 1b shows a perforated piece of the composite liner as being dispensed.

FIG. 1c shows three layers of the composite liner, artificially separated for illustration.

FIG. 2 shows another perforated piece of the composite liner as being dispensed.

FIG. 3 illustrates an example of how seams can be laid out.

### DETAILED DESCRIPTION OF THE INVENTION

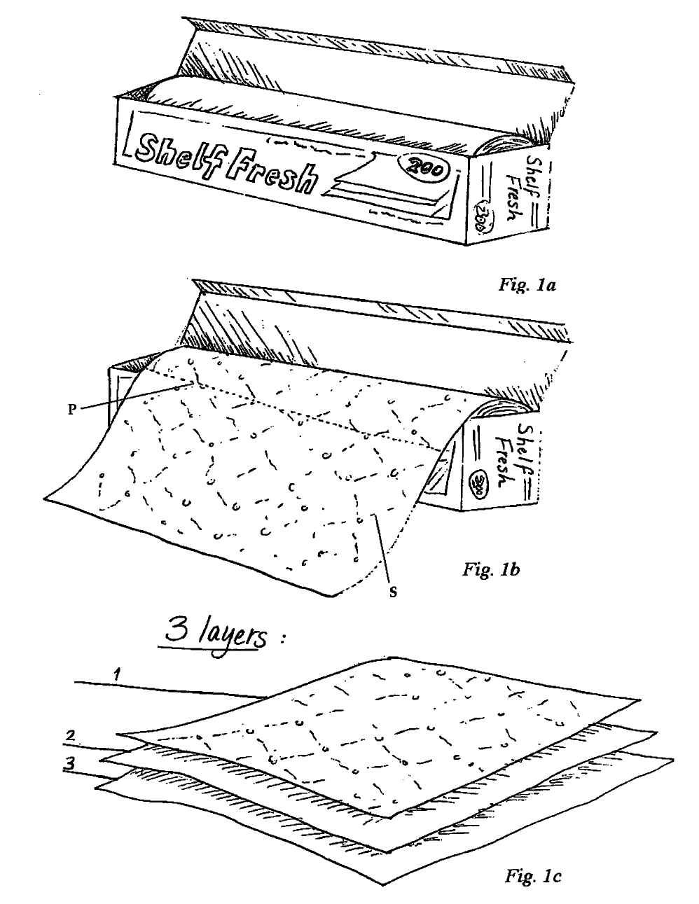

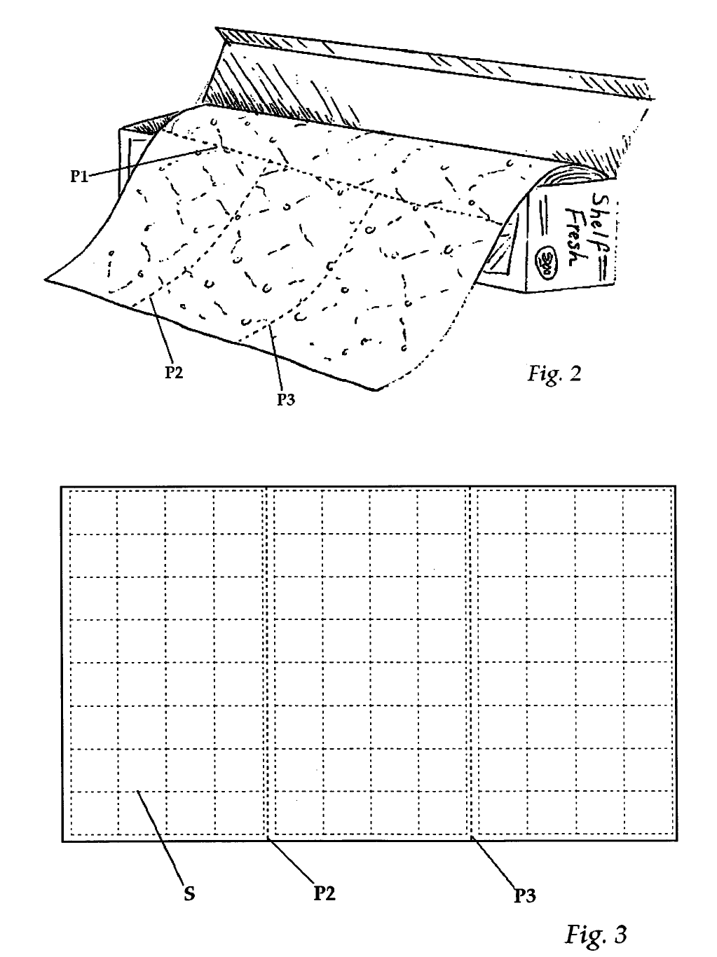

The composite liner is designed, in one embodiment, to be pulled out of a packaged roll (FIG. 1a) much like wax paper or the like is dispensed. The composite liner can, for example, have a perforated quilted surface. The composite liner absorbs spills, prevents spill material from hardening on the underlying surface, and reduces spill odor.

As illustrated in FIG. 1c, the composite comprises three layers. Water-impermeable layer 3 can be tacky. If tacky, it is sufficiently tacky to help seat it on a wide variety of surfaces, similar to the tackiness of common kitchen plastic wraps. Accordingly, “tacky” does not require an adhesive or adhesiveness, merely a tendency a resist slipping on materials such as those on which kitchen wraps resist slipping. The tacky quality can be such that it does not interfere with rolling composite into a roll, such as illustrated in FIG. 1a. “Water-impermeable” means sufficiently water impermeable to facilitate clean up after spills of food products.

Odor absorbent layer 2 comprises an odor-absorbent, such as baking soda, activated charcoal, or the like. The odor absorbent can be limited in movement such as by being infused into a matrix such as a fiber mesh (such as a non-woven web or absorbent paper product) or by being in pockets formed by welds between the water-impermeable layer 3 and the water-absorbent layer 2. The layers can be bonded, for example by heat or ultrasonic welding, with adhesive, or with any other method used to adhere fiber and plastic layers. Where there is no mesh in odor absorbent layer 2, as in other embodiments, seams S (FIG. 3) can be formed by bonds between layers 1 and 3 or by bonds from layer 1 to layer 2 and layer 2 to layer 3. The seams can be continuous or segmented (comparable to stitches). In either case, they can serve to limit the mobility of the odor absorbent. In certain embodiments there are perforations (P, P1, P2, P3) positioned to allow the composite liner to be separated into useful sized pieces. As illustrated in FIG. 3, the seams can be positioned to work with the perforations such that minimal amounts of odor absorbent is lost when the perforations are used. Or, even if a more colorful, less regimented pattern of seams is used, the seam pattern will limit loss at the perforations.

The perforations can, for example, be placed to allow for separating segments of 90 in² or less in area, or 89 in² or less in area, 88 in² or less in area, or 87 in² or less in area, 86 in² or less in area, or 85 in² or less in area, 84 in² or less in area, or 83 in² or less in area, 82 in² or less in area, or 81 in² or less in area, 80 in² (80×6.4516 cm²=516.128 cm²) or less in area, or 79 in² or less in area, or 78 in² or less in area, or 77 in² or less in area, or 76 in² or less in area, and so on (in 1 in² increments) to 5 in² or less in area. These area parameters can be combined with the parameters: 4 in² or more in area, 5 in² or more in area, 6 in² or more in area, 7 in² or more in area, and so on (in 1 in² increments) to 50 in² or more in area. The perforations can, for example, be placed to allow composite liner dispensed from a roll (e.g., 10.5 in, 11 in, 12 in wide) to be dispensed in segments of 9 in or less in length, or 8 in or less in length, or 7 in or less in length, or 6 in or less in length. The perforations allow the composite liner to be more conveniently used in a wide variety of locations. For example, with appropriate perforations, the size of the composite liner can be roughly matched to the area under a refrigerator drawer (or a little more), to provide a catch for spills at or above the drawer.

In certain embodiments the odor absorbent, in the commercial product as it will be sold, is a particulate material such as baking soda (such as powdered or crystalline sodium bicarbonate), another metal bicarbonate, or activated charcoal. The odor absorbent can be precipitated in place from solution and the absorbent layer dried for assembly into the composite.

In certain embodiments, the total thickness of the composite liner is 100 mils or less [=0.1 inch, or 2.54 mm or less], 99 mils or less, 98 mils or less, 97 mils or less, 96 mils or less, and so on (in 1 mil increments) to 40 mils or less. This thickness can be selected in light of the typical clearance, for example, between a refrigerator drawer and the underlying structure.

The water-impermeable layer can be, for example, formed of polyvinylidene chloride, polyvinylchloride, or another suitable polymer (e.g., such as described in U.S. Pat. No. 6,858,288 or U.S. Pat. No. 6,723,446). The thickness can be selected to be similar to that in a food storage wrap, or can be thinner, especially where the structure of odor absorbent layer 2 can provide much of the structural strength. Thus, for example, the thickness can be 3 micron or more, 4 micron or more, 5 micron or more, or 6 micron or more, or 7 micron or more, or 8 micron or more, or 10 micron or more, or 11 micron or more, or 12 micron or more, or 13 micron or more, or 14 micron or more. The thickness can, for example, be 35 micron (roughly 1 mil) or less, or 34 micron or less, or 33 micron or less, or 32 micron or less, or 31 micron or less, or 30 micron or less, or 29 micron or less, or 28 micron or less, or 27 micron or less, or 26 micron or less, or 25 micron (roughly 1 mil) or less, or 24 micron or less, or 23 micron or less, or 22 micron or less, or 21 micron or less, or 20 micron or less, or 19 micron or less, or 18 micron or less, or 17 micron or less, or 16 micron or less, or 15 micron or less, or 14 micron or less, or 13 micron or less, or 12 micron or less.

Places where the composite liner can be used include, for example, shelving (including refrigerator or freezer shelving, or utility shelving for storing materials susceptible to problem spills such as paint and other household liquids), the space under drawers used in spill-susceptible places (such as freezers or refrigerators), to line liter boxes, diaper changing surfaces, trash bins, garbage bins, recycling bins, trash compactors, and the like.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A composite liner material comprising:
a water-impermeable layer;
sandwiched between the water-impermeable layer and a water-absorbent layer, a layer comprising an odor absorbent; and
the water absorbent layer, wherein the three layers are flexible and sufficiently bonded so that the composite is conveniently manipulated for use as a liner.

2. The composite liner of claim 1, wherein the water-impermeable layer is tacky but reversibly removable from a lined surface.

3. The composite liner of claim 2, provided in a roll comprising perforations for separating individual segments of composite liner, and essentially free of a separate release layer.

4. The composite liner of claim 1, wherein the water-impermeable layer is a plastic film.

5. The composite liner of claim 1, wherein the odor absorbent is baking soda.

6. The composite liner of claim 1, wherein the odor absorbent layer is a mesh infused with the odor absorbent.

7. The composite liner of claim 6, wherein odor absorbent is baking soda.

8. The composite liner of claim 1, further comprising:
packaging comprising instructions on using the liner as a protective liner.

9. The composite liner of claim 1, provided in a roll comprising perforations for separating individual segments of composite liner.

10. The composite liner of claim 9, wherein the perforations allow for separating segments of 90 in² or less in area.

11. The composite liner of claim 9, wherein the perforations are placed a intervals (along the dimension that is rolled up) of 9 in or less.

12. A method of lining a surface subject to spills comprising placing on the surface the composite liner of claim 1 with the tacky layer adjacent to the surface.

13. The method of claim 12, wherein the liner is used in space immediately underneath refrigerator or freezer drawers.

14. The method of claim 12, wherein the liner is used under absorbent liter material in a liter box.

15. The method of claim 12, wherein the liner is used to cover a diaper changing table.

16. The method of claim 12, wherein the liner is used to line shelving.
